(19) United States
(12) Patent Application Publication
(10) Pub. No.: US 2013/0056458 A1
(43) Pub. Date: Mar. 7, 2013

(54) METHOD AND DEVICE FOR FORMING ATOMIC CLOCK

(71) Applicant: WUHAN INSTITUTE OF PHYSICS AND MATHEM, Wuhan (CN)

(72) Inventors: Enxue YUN, Wuhan (CN); Wei DENG, Wuhan (CN); Yi ZHANG, Wuhan (CN); Sihong GU, Wuhan (CN)

(73) Assignee: WUHAN INSTITUTE OF PHYSICS AND MATHEMATICS, CHINESE ACADEMY OF SCIENCES, Wuhan (CN)

(21) Appl. No.: 13/668,374

(22) Filed: Nov. 5, 2012

Related U.S. Application Data
(63) Continuation-in-part of application No. PCT/CN2010/079623, filed on Dec. 9, 2010.

(30) Foreign Application Priority Data
May 5, 2010 (CN) 201010169079.2

(51) Int. Cl. H05B 11/00

(52) U.S. Cl. 219/680

(57) ABSTRACT

A method for forming an atomic clock, including: a) connecting an output terminal of a current source to a DC input terminal of a DC bias element, and connecting an output terminal of a microwave source to a high-frequency RF input terminal of the DC bias element through a microwave switch to generate a circular polarization laser; b) feeding the circular polarization laser into an atom sample bubble to interact with an alkali-metal atom, and controlling the current source through control equipment; c) modulating output current, and demodulating detection light intensity; d) controlling the microwave switch to produce a Ramsey-CPT interference fringe; and e) modulating the microwave frequency, demodulating light intensity, employing a central fringe as a frequency discrimination signal, and locking the microwave frequency at maximum peak position of the central fringe to output stable frequency of the atomic clock.

### CROSS-REFERENCE TO RELATED APPLICATIONS

This application is a continuation-in-part of International Patent Application No. PCT/CN2010/079623 with an international filing date of Dec. 9, 2010, designating the United States, now pending, and further claims priority benefits to Chinese Patent Application No. 201010169079.2 filed May 5, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to an atomic clock, and more particularly to a method and a device for forming a Ramsey-CPT atomic clock using the On-Off of a microwave. The method and device can be applied to form atomic clocks, especially form miniature high performance chip scale atomic clocks (CSAC), and also applied to precise measurement equipment such as magnetometer.

2. Description of the Related Art

Microwave modulates a vertical cavity surface emitting laser device (VCSEL) to generate coherent polychromatic light. Coherent population trapping (CPT) state can be prepared through interaction between bicolor light consisting of plus/minus grade 1 sideband and an atom, therefore electromagnetically induced transparency (EIT) phenomenon is acquired. EIT spectral line can be far narrower than line width for preparation of CPT laser, reaching a degree similar to an atom microwave transition spectral line. High resolution EIT spectral line can sensitively determine the deviation of microwave frequency, and feedback its differential curve as a frequency discrimination signal of local frequency deviation to local frequency for locking, so as to get standard frequency output. This is the basic working theory of passive CPT atomic clock (hereunder abbreviated as CPT atomic clock) of continuous light action. Its working process is as follows: getting Doppler widened atom resonance absorption spectral line of atom transition through scanning the fundamental frequency of laser, locking laser frequency at the center of resonance absorption spectral line, then scanning the microwave frequency coupled on a laser device to get EIT spectral line, and locking microwave frequency at the center of CPT peak to get atomic clock frequency output of high stability. Featuring low power consumption and easy miniaturization, CPT atomic clock provides a powerful tool for time frequency standard of high stability under extreme conditions of space and power consumption restriction. Physical system of miniature CPT atomic clock can be used as a high resolution magnetic field probe, so as to accurately measure change of space and time of weak magnetic field intensity.

CPT atomic clock adopts the working mode of interaction between continuous laser and an atom, while Ramsey-CPT atomic clock combines CPT resonance with Ramsey interference, which is a new atomic clock that uses interaction between pulse laser and an atom. The frequency standard generates interaction between bicolor light and an atom through a VCSEL. Firstly, prepare an atom to CPT state, then generate Ramsey interference effect by using pulse light, and scan the microwave frequency coupled on a laser, so as to get Ramsey interference fringe signal of which spectral line is narrower and Signal Noise Ratio is higher than the EIT spectral line acquired through continuous light action. As correction signal, the differential curve of the interference fringe is fed back to local frequency for forming an atomic clock. The atomic clock based on Ramsey-CPT interference theory features time frequency output better than CPT atomic clock, frequency stability higher than CPT atomic clock by one magnitude, and smaller optical frequency shift. However, existing Ramsey-CPT atomic clock uses acousto-optic modulator (AOM) as an optical switch for generation of pulsed laser, due to large volume and high power consumption of AOM, development of Ramsey-CPT atomic clock towards miniature and low power consumption atomic clock has been restricted.

### SUMMARY OF THE INVENTION

In view of the above-described problems, it is one objective of the invention to provide a method for forming a Ramsey-CPT atomic clock through cyclic on-off of microwave. The method improves the structure of Ramsey-CPT atomic clock, simplifies the test device, enhances the stability of CPT atomic clocks, and makes a breakthrough of theoretical restriction for forming of miniature and micro power consumption of Ramsey-CPT atomic clock.

It is another objective of the invention to provide a device for forming a Ramsey-CPT atomic clock that has an innovative design, simple and miniature structure, and low power consumption.

On the basis of an existing CPT atomic clock, a VCSEL is modulated through cyclic on-off of microwave to achieve interaction between an atom and light. Under ON state of the microwave, bicolor laser excites an atom into a CPT state; under OFF state of the microwave, laser is off resonance with the atom, therefore there is no prominent interaction, and the CPT state evolves freely during the period. When the microwave is turned ON again, as there is phase difference between the CPT state and Raman frequency of the laser, the atom of CPT state and incident light field modulate each other, interference fringe can be observed on transmitted light intensity, i.e. Ramsey-CPT interference. Thus, Ramsey-CPT interference is achieved by control of microwave On-Off through electronics method, so that an atomic clock with stability higher than a CPT atomic clock is achieved, and advantages of the CPT atomic clock such as miniaturization and low power consumption are maintained.

To achieve the above objectives, in accordance with one embodiment of the invention, there is provided a method for forming an atomic clock. The method comprises the steps as follows:
1) Connecting an output terminal of a current source to a DC input terminal of a DC bias element (Bias-Tee), connecting an output terminal of a microwave source to a high-frequency RF input terminal of the DC bias element through a microwave switch, coupling DC with microwave by the DC bias element to get a current modulated with microwave, of which DC bias size, microwave frequency and power are controllable; feeding the current into a laser device to generate coherent multi-side-band laser; adjusting adjacent side-band spacing with coupling microwave frequency, adjusting side-band amplitudes with microwave power to meet Bessel function mode, and selecting modulation index as approximately 1.6 so that the plus/minus grade I side-band optical power is maximum, adjusting output laser intensity through an attenuator, and adjusting output laser polarization direction by a λ/4 wave plate to generate a circular polarization laser;
2) Feeding the circular polarization laser into an atom sample bubble to interact with an alkali-metal atom, and measuring the transmitted light intensity through a laser detector. FIG. 1 shows an atom A three-level energy grade structure model and corresponding laser spectrum character. Adjusting DC current inputted by the laser device, so that the laser device outputs laser of fundamental frequency f₀, adjusting microwave frequency generated by the microwave source as Δf/2, so as to get the polychromatic light after microwave modulation, of which frequency of the plus/minus grade I side-band is f₀±Δf/2, respectively corresponding to f₁ and f₂ of the atom A three-level structure model. Controlling the current source through control equipment for DC scanning, changing the fundamental frequency of laser outputted by the laser device, and recording transmitted light intensity, so as to get multiple absorption peaks generated by interaction between polychromatic light and the atom A three-level. FIG. 2 shows the multiple absorption peaks acquired through DC scanning. After completion of scanning, setting the output of current source as the current value corresponding to maximum absorption peak.
3) Modulating current outputted by the current source, demodulating detection light intensity to get differential curve corresponding to absorption peak. Based on feedback DC of differential curve, adjusting DC output so that it corresponds to the position of maximum absorption peak. At the moment, frequency f₁ and f₂ of plus/minus grade I side-band of laser outputted by the laser device correspond to transition frequency ν₁ and ν₂ between two basic states and excited state in an atom Λ three-level structure model (FIG. 1).
4) Controlling the microwave switch, getting a cyclic microwave pulse, at the moment laser output is an equivalent pulse, so as to achieve cyclic interaction between laser and atom. FIG. 3 shows the microwave pulse time sequence in one cycle t₀ and corresponding output laser frequency character. Each cycle t₀ comprises two pulses, duration time of the first pulse and the second pulse are respectively τ₁ and τ₂, the interval time between two pulses is T, the interval between the second pulse and the first pulse of the next cycle is T′, upon instance τ₁ and τ₂, microwave switch turns microwave ON, laser device is modulated to output polychromatic light of fundamental frequency f₀, in which plus/minus grade I side-band f₁ and f₂ interact with atom so as to prepare CPT state and generate Ramsey interference, microwave switch turns microwave off upon instance T, laser device outputs homogeneous light, laser frequency is off resonance, atom evolves freely, microwave is off upon instance T′, so as to eliminate the effect of the last cycle, control microwave source through control equipment for scanning microwave frequency, change frequency difference of plus/minus grade I side-band outputted by laser device, i.e. change Raman off resonance, make records of transmitted light intensity, so as to get Ramsey-CPT interference fringe. Determine appropriate pulse time sequence through experiment, so as to get the Ramsey-CPT interference fringe of narrow line width and high signal noise ratio. For microwave pulse series, design rational ascending and descending edge, so that the negative Chirp effect of VCSEL upon Ramsey-CPT is minimized, which is a critical technical process. FIG. 4 shows the Ramsey-CPT interference fringe achieved through microwave On-Off under condition that τ₁, τ₂, T and T′ are respectively 0.2 ms, 2 ms, 0.5 ms, and 10 ms.
5) Controlling the microwave source for modulation of microwave frequency, control equipment demodulates light intensity, so as to get differential curve corresponding to the Ramsey-CPT interference fringe, central fringe is used as a frequency discrimination signal, microwave frequency is locked at maximum peak position of central peak of Ramsey-CPT interference fringe, at the moment microwave output frequency is Δf/2 and meets Raman resonance, through lock of microwave frequency, stable frequency output of atomic clock is achieved. It is also allowed to get magnetic sensitive CPT spectral line narrower than existing CPT magnetometer by using the Ramsey-CPT interference fringe achieved in this program, so as to achieve precise measurement of magnetic field.

In accordance with another embodiment of the invention, there provided is a device for forming a Ramsey-CPT atomic clock, comprising: a current source, a microwave source, a microwave switch, a DC bias element (Bias-Tee), a laser generator, a physical system, a laser detector, and control equipment. An output of the current source is connected with a DC bias input terminal of the Bias-Tee, and an output of the microwave source is connected with the microwave switch. Cyclic on-off microwave is generated through the microwave switch. The Bias-Tee is a three-port device, two input terminals are respectively connected with the DC power supply and the microwave switch, an output port is connected with the laser generator. The current source and microwave source provide bias current and microwave modulation to the laser generator connected on the output port through the Bias-Tee. Laser outputted by the laser generator projects onto the laser detector through the physical system. The laser detector detects the light intensity transmitted after absorption by the physical system, photoelectric cell converts optical signal into electrical signal, and voltage signal which can be processed by the control equipment through conversion of current into voltage and amplifying circuit. The control equipment is respectively connected with output of the current source, microwave source, microwave switch and laser detector. The control equipment collects and processes voltage signal outputted by laser detector, and controls output of the current source and microwave source and on/off of microwave switch.

FIG. 6 shows a block diagram of the laser generator, which comprises a vertical cavity surface emitting laser device (VCSEL), laser device temperature controller, attenuator, and λ/4 wave plate. The vertical cavity surface emitting laser device is respectively connected with the output port of the Bias-Tee and the laser device temperature controller, laser transmitted by the vertical cavity surface emitting laser device is outputted after passing the attenuator and λ/4 wave plate. The laser device temperature controller controls temperature of the laser device, so as to ensure stable work of the laser device. The attenuator is used for adjustment of light intensity of outputted laser, the λ/4 wave plate is used to change polarization of outputted laser, so that linear polarization outputted by the vertical cavity surface emitting laser device is converted into circular polarization light.

FIG. 7 shows a block diagram of the physical system, comprising an atomic sample bubble, magnetic field coil, magnetic shielding layer, and temperature controller of physical system. The atomic sample bubble is a sealed glass bubble charged with ⁸⁷Rb atom and buffer gas, and the atomic sample bubble are surrounded with the magnetic field coil and the magnetic shielding layer. The temperature controller provides stable working temperature for the atomic sample bubble. Polychromatic light generated and modulated by the laser generator passes along the axial direction of the atomic sample bubble and magnetic field coil, during the process, light interacts with atom to prepare CPT state.

FIG. 8 shows a block diagram of the control equipment, comprising data collection hardware, output hardware of computer/micro-controller, and a communication interface. The control equipment can be a computer or micro-controller comprising hardware and software, in which the hardware is used for realization of input and output of analog signal, conversion between analog signal and digital signal and control of instruments such as current source and microwave source, while the software is used for processing and feedback of data, and control of work procedure of the entire system.

Advantages of the invention are summarized as follows:
1. Ramsey-CPT interference fringe is achieved through modulation of a VCSEL by cyclic on-off of microwave, and thus narrower line width and higher signal noise ratio are obtained in comparison with CPT atomic clock. The method features better frequency discrimination curve and higher stability of atomic clock.
2. The atomic clock has a simple structure, and advantages such as miniaturization and low power consumption of CPT atomic clock are maintained. In comparison with existing Ramsey-CPT program, this method achieves cyclic interaction between laser and atom through cyclic On-Off of microwave, of which the effect is equivalent to cyclic interaction between laser pulse generated by optical switch instrument (AOM) and atom. In comparison with Ramsey-CPT atomic clock program using AOM for generation of laser pulse, this program has cancelled optical switch instrument, thus saving volume and power consumption, the complete machine of chip size can be achieved through integrated circuit and micro-processing technique. This method solves theoretical restriction and technical bottleneck of chip scale Ramsey-CPT high performance atomic clock (CSAC).
3. Digitalization of analog signals during signal processing reduces the possibility of interference of signal, meanwhile, utilization of software enables convenient introduction of more data processing method, enhancing flexibility of data processing. Realization of digital modulation/demodulation simplifies circuit.

### BRIEF DESCRIPTION OF THE DRAWINGS

FIG. 1 is a schematic diagram of a typical three-level structure model of an atom and corresponding spectrum character, in which, E1, E2, and E3 are three energy levels of the atom, ν₁ is transition frequency between energy level E1 and E3, and ν₂ is transition frequency between energy level E2 and E3. f_{VCSEL} is an output frequency spectrum of a VCSEL laser device, of which the fundamental frequency is f₀, f₊₁ and f₋₁ are respectively plus/minus grade I side-band of laser device, respectively corresponding to the transition frequency ν₁ and ν₂.

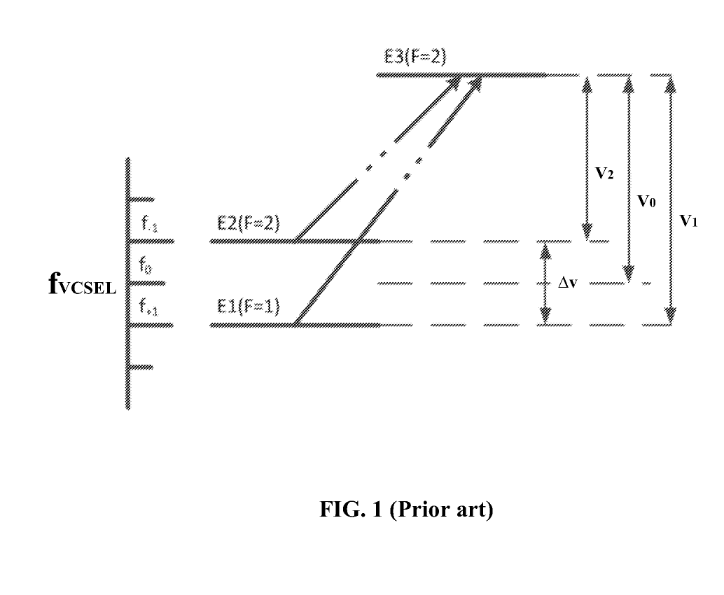

FIG. 2 shows an absorption peak acquired through action of bicolor light (modulation index 1.6) and a three-level structure model of an atom.

FIG. 3 is a schematic diagram of microwave pulse time sequence and corresponding output laser spectrum character, in which, t₀ is pulse cycle, τ₁ and τ₁ are respectively time of two pulses, T is pulse interval time, and T′ is free evolution time.

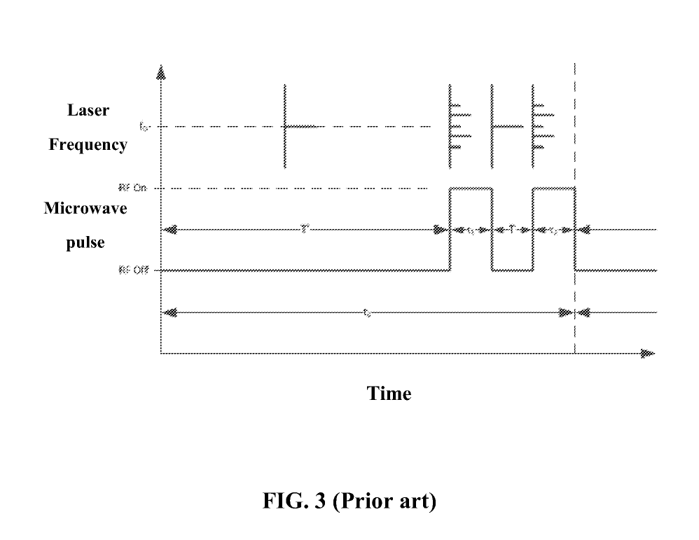

FIG. 4 shows a Ramsey-CPT interference fringe acquired through cyclic on-off of microwave in accordance with one embodiment of the invention.

FIG. 5 is a schematic diagram of a device for forming a Ramsey-CPT atomic clock through cyclic on-off of microwave in accordance with one embodiment of the invention.

FIG. 6 is a schematic diagram of a laser generator in accordance with one embodiment of the invention.

FIG. 7 is a block diagram of a physical system in accordance with one embodiment of the invention.

FIG. 8 is a block diagram of control equipment in accordance with one embodiment of the invention.

FIG. 9 is a schematic diagram of time sequence of microwave control signal, in which, S1 is a signal for controlling a microwave switch, S2 is a triggering signal modulated by microwave, and S3 is a triggering signal scanned by microwave, T₀ is a cycle of control signal, two cycles of microwave pulse are outputted in each T₀ cycle, t₀ is a cycle of pulse microwave, τ₁ and τ₁ are respectively time of two pulses, T is pulse interval time and T′ is free evolution time.

FIG. 10 is a flow chart of system control software in accordance with one embodiment of the invention.

### DETAILED DESCRIPTION OF THE EMBODIMENTS

To further illustrate the invention, experiments detailing an 87Rb atom Ramsey-CPT atomic clock are described. It should be noted that the following examples are intended to describe and not limited to the invention.

A method for forming an atomic clock through modulation of VCSEL by On-Off of microwave is described as follows.

1. A laser detector converts an optical signal into an electrical signal. Through data collection hardware, control equipment converts an analog signal into a digital signal, which are read and processed by a computer or micro-controller. Through a communication interface, the computer or micro-controller controls a current source and a microwave source. Frequency of output current of the current source and output microwave of the microwave source can be controlled by the control equipment, featuring continuous scanning, fixed output and any waveform output. Meanwhile, switching signal and modulating signal can be outputted by signal output hardware for microwave switch control and microwave modulation respectively.

2. Turn on a laser device temperature controller 12 and a temperature controller 24 of a physical system. Perform temperature control of a laser device and the physical system, so that the laser device temperature can be stabilized at 40° C. and the physical system temperature at 70° C., and wait for temperature stabilization. Turn on power to a magnetic field coil 22. The inputted current is 2 mA to generate a magnetic field of approximately 100 mG. Turn on the current source 1 and the microwave source 2, and connect the microwave switch 3, a DC bias element (Bias-Tee) 4 and a VCSEL 11. Set output current of the current source as 1.2 mA. Adjust the angle of an attenuator 13, so that the transmitted light intensity is within linear work area of photoelectric cell. Adjust the angle of a λ/4 wave plate 14, so that laser changes into circular polarization after passing the λ/4 wave plate. Turning on the control equipment, collect output signals of the laser detector 7 through data collection equipment.

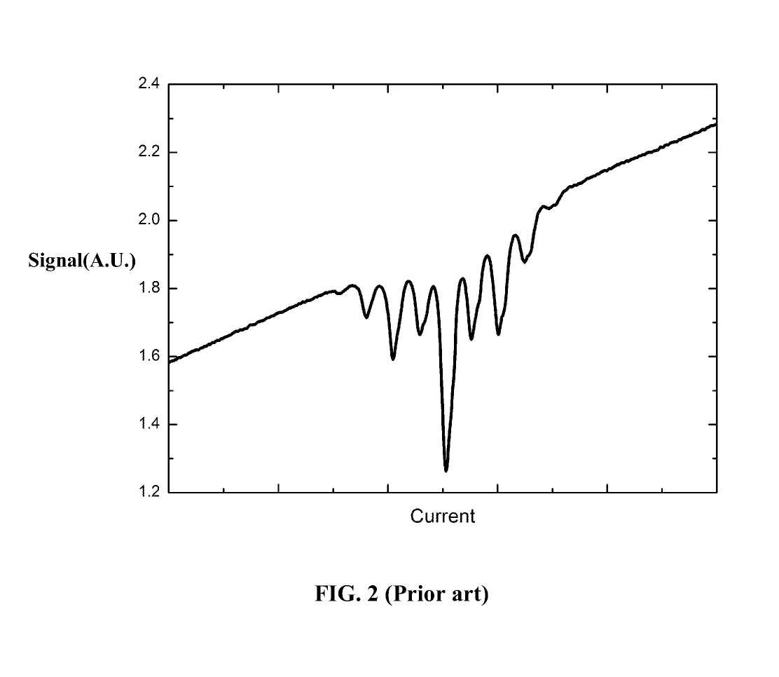

3. Set the current source 1 as a scanning mode, and the scanning scope is from 1.1 mA to 1.3 mA. Set output frequency of the microwave source 2 as 3.417 GHz and microwave power as 2.5 dbm. Set the microwave switch 3 as ON state. Turn on microwave output, and start DC scanning Doppler absorption peak of photoelectric cell output signal can be seen through the data collection equipment, as shown in FIG. 2. Control program to look for the position of maximum absorption peak, then set the current source as fixed output mode, so that the output signal of the photoelectric cell is stabilized on the position of maximum absorption peak.

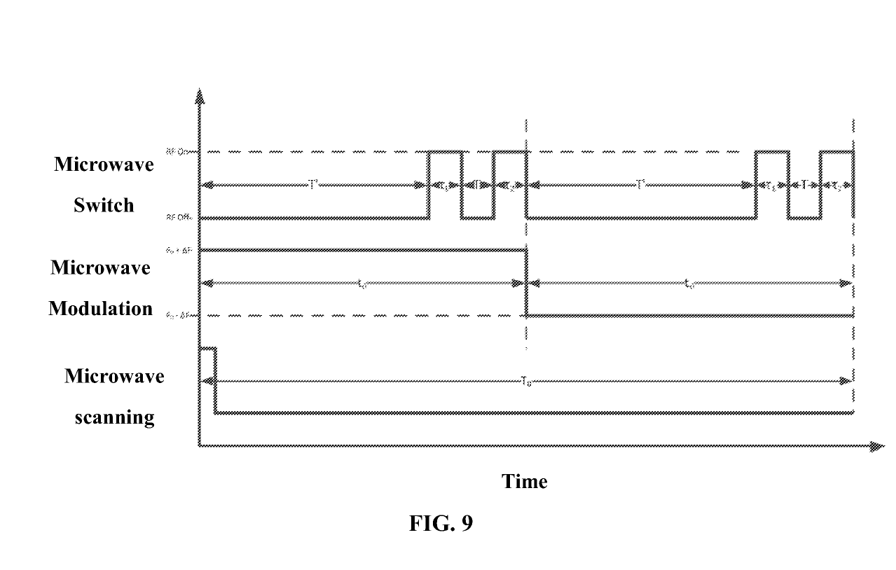

4. Set the microwave source 2 as a scanning mode, and the t scanning scope is from 3.417341300 GHz to 3.417346300 GHz, step size is 2 Hz, and dwelling time at each scanning point is T0. Modulation mode is binary system frequency shift key control (2FSK) modulation, modulation depth ΔF is 160 Hz, and modulation cycle is T0. Cycle of the microwave switch control signal is t0, and two pulses are generated in each cycle. FIG. 9 shows the time sequence of the microwave switch signal and triggering signal. The switch control signal (Switch) outputted by the signal output equipment controls the microwave switch, the scan triggering signal (Scan) and modulation triggering signal (Mod) respectively control scan and modulation of the microwave source. The control signal controls microwave output of the microwave source (RFout) so that fundamental frequency of each T0 cycle is increased by step size 2 Hz, meanwhile modulation of cycle T0 and modulation depth 160 Hz is available. The output passes the microwave switch before outputting microwave pulse that is turned on/off as per microwave switch control signal.

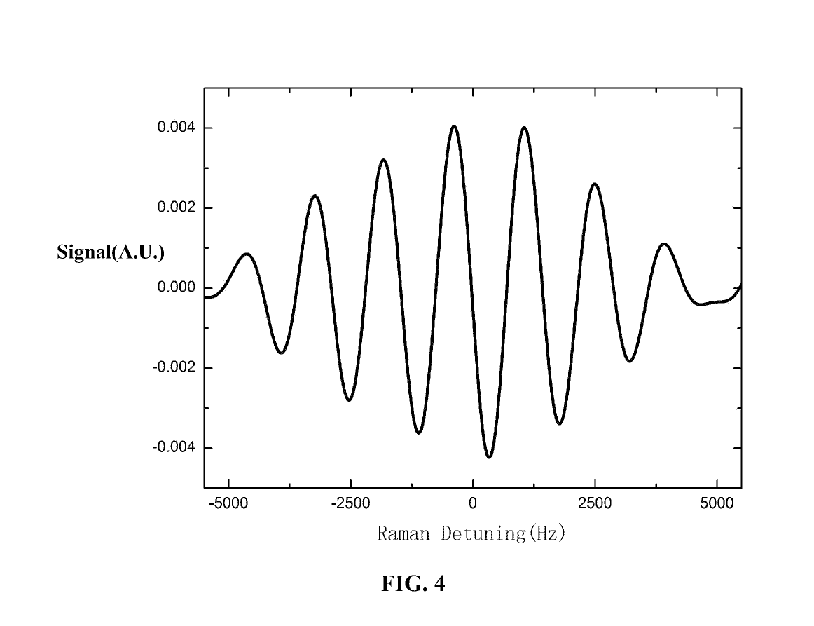

5. Collect an output signal of the photoelectric cell through the data collection equipment, sampling rate is set as 1 Mbps and sampling accuracy is 14-bit. Among the sampling results of each T0 cycle, take the results of 2^{nd} pulse and 4^{th} pulse in close adjacency of ascending edge, the Ramsey-CPT signal under different modulations can be acquired through average and filtration, calculate the difference of the two results so as to get the differential Ramsey-CPT signal. Scan microwave, and record the change curve of differential Ramsey-CPT signal in relation to microwave frequency (half of the Raman detuning) so as to get the differential curve of the Ramsey-CPT interference fringe (as shown in FIG. 4).

6. Feed back the frequency outputted by the microwave source on the basis of the differential signal to achieve the purpose of stabilization of microwave frequency, and thus achieve frequency output of atomic clock that meets requirements and features high stability through frequency division of microwave.

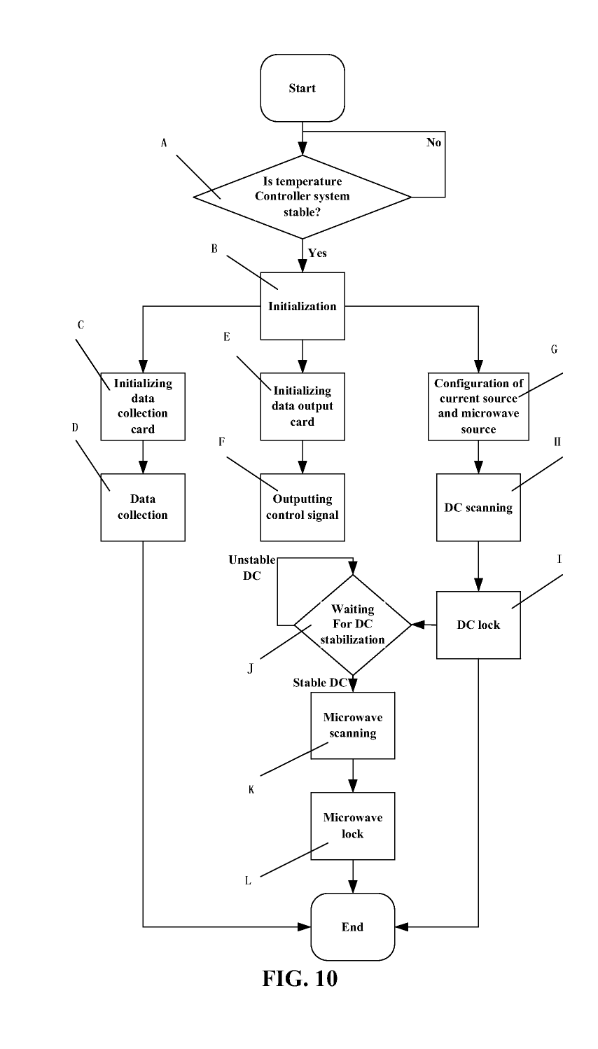

FIG. 10 shows the program operating on a computer 32 during an example, which is programmed by adoption of LabVIEW language, and can be compiled by common technicians as per basic knowledge. Partial functions comprise flow control, signal collection/processing and control of instrument. Detailed flow of the program is given as follows:

1. After starting program, determine whether temperature controller system is stable (process A), continue waiting in case temperature is not stable, and proceed with initialization if temperature gets stable (process B).

2. Initialize a data collection card (process C), set input scope of the collection card as from −10 V to +10 V, sampling rate as 10 M, and sampling method as continuous sampling. After completion of the initialization of the collection card, read data from the collection card by continuous mode (process D).

3. Initialize a data output card (process E), set the output mode as three-channel digital signal output, which are respectively used for control of the microwave switch, microwave source modulation departure and microwave source scan departure, and the output signal is TTL level. After completion of the initialization, output control signal continuously (process F).

4. Turn on a GPIB communication interface, and configure the current source and the microwave source (process G).

5. Configure the microwave source as fixed output, microwave modulation and scanning signal off, and configure the current source output as a scanning mode, start DC scanning (process H), meanwhile record light intensity signal collected.

6. Perform DC lock (process I) after completion of the DC scanning, look for the minimum value of the acquired light intensity signal, which is the minimum point of Doppler absorption peak, configure current source so that its output corresponds with the point.

7. Wait for DC stabilization (process J), proceed with microwave scanning (process K) if DC is stable. Configure the current source as fixed output, turn on microwave modulation and scanning signal, and start microwave scanning (process K). Meanwhile, record the differential signal of Ramsey-CPT acquired.

8. Perform microwave lock (process L) after completion of the microwave scanning, look for the maximum value and minimum value of Ramsey-CPT differential signal, with the scope between the maximum value and minimum value corresponding to central peak of Ramsey-CPT, look for the crossover point between the maximum value and minimum value with the point corresponding to central peak, configure the microwave source so that its output corresponds with the point and continuously feeds back microwave output frequency through differential signal, realizing lock of frequency.

A device for forming an atomic clock comprises: a current source 1, microwave source 2, microwave switch 3, DC bias element (Bias-Tee) 4, laser generator 5, physical system 6, laser detector 7, and control equipment 8. The laser generator 5 comprises a vertical cavity surface emitting laser device (VCSEL) 11, laser device temperature controller 12, attenuator 13, and λ/4 wave plate 14. The physical system 6 comprises an atom sample bubble 21, magnetic field coil 22, magnetic shielding layer 23, and temperature controller 24. The control equipment 8 comprises a data collection hardware, computer/microcontroller, signal output hardware, and communication interface.

The current source 1 adopts Keithley 6220 precise current source with source current and sink current scope from 100 fA to 100 mA, built-in RS-232, GPIB, triggering link and digital I/O interface, control equipment controls its current output through GPIB interface, so as to achieve current scanning or fixed output current.

Adopting Agilent E8257D microwave source, of which microwave output scope is from 250 kHz to 20, the microwave source 2 features ascending/descending time of 8 ns and pulse width 20 ns, a modular microwave signal generator can selectively add AM, FM, ØM and/or pulse, and the control equipment 8 is controlled through GPIB interface.

The microwave switch 3 adopts ZYSWA-2-50DR of Mini-Circuits. It features band width of DC to 5 GHz and built-up time of 6 ns.

The DC bias element (Bias-Tee) 4 adopts ZNBT-60-1 W+Bias-Tee of MINI Company, of which pass band frequency is 6 GHz.

The laser generator 5 comprises the VCSEL 11 with wavelength around 795 nm, of which the output laser wavelength is related to input current size, the larger the input current, the longer the output laser wavelength, and the lower the frequency, the line width of output laser is approximately 100 MHz, the laser device temperature controller 12 comprises a thermal resistor and TEC for control of temperature of the VCSEL.

The physical system 6 comprises an atom sample bubble 21, magnetic field coil 22, magnetic shielding layer 23 and temperature controller 24. The atom sample bubble 21 is charged with atom (87 Rb) and a certain proportion of buffer gas (nitrogen and methane), of which pressure is 23.5 Torr, and pressure ratio of nitrogen to methane is 2:1. The magnetic field coil 22 is made of copper wire, in which the magnetic field of approximately 100 mG will be generated in case of connection of current 2 mA. Made from permalloy, the magnetic shielding layer 23 is located outside the magnetic field coil for shielding external magnetic field. The temperature controller 24 comprises a heating wire and thermistor for measurement and control of atom sample bubble temperature.

The laser detector 7 comprises a photoelectric cell and current-to-voltage circuit. The photoelectric cell adopts Hamamatsu s1223, which converts optical signal into electrical signal, and the current-to-voltage circuit converts current output of the photoelectric cell into voltage output.

A data collection card 31 adopted by the control equipment 8 is PCI-5122 high speed digitizer of NI company, which features sampling rate 100 MS/s and high resolution of 14-bit. Through connection between the data collection card and the output signal of the laser detector, the computer achieves collection of light detection output signal and conversion from analog signal to digital signal. PCI-6220 of NI company is adopted for the control card 33 and GPIB communication interface is adopted for connection between the computer and the current source and microwave source. A common computer 32 processes the collected data, configures the output of current source and microwave source, and controls signal outputted by the control card 33.

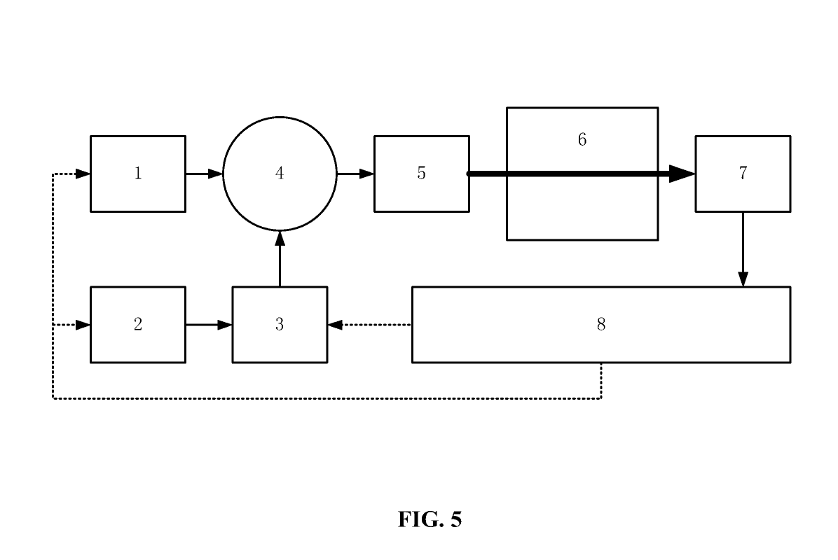

The connection relationship between the components is shown in FIG. 5: the output terminal of the current source 1 is connected with the DC bias input port of the Bias-Tee, and the output port of the microwave source 2 is connected with the microwave switch 3. Cyclic on-off microwave is generated through the microwave switch. The bias-Tee is a three-port device, of which two input ports are respectively connected with the current source 1 and the microwave switch 3, an output port is connected with the laser generator 5. The current source 1 and microwave source 2 provide bias current and microwave modulation to the output port of the laser generator 5. Laser outputted by the laser generator 5 projects onto the laser detector 7 through the physical system 6. The laser detector 7 detects the light intensity transmitted after absorption by the physical system 6, the photoelectric cell converts optical signal into electrical signal, and into voltage signal which can be processed by the control equipment through conversion of current into voltage and amplifying circuit. The control equipment 8 is respectively connected with the current source 1, microwave source 2, microwave switch 3 and the output terminal of the laser detector 7. The control equipment 8 collects and processes voltage signal outputted by the laser detector 7, and controls output of the current source 1 and microwave source 2 and on/off of the microwave switch 3.

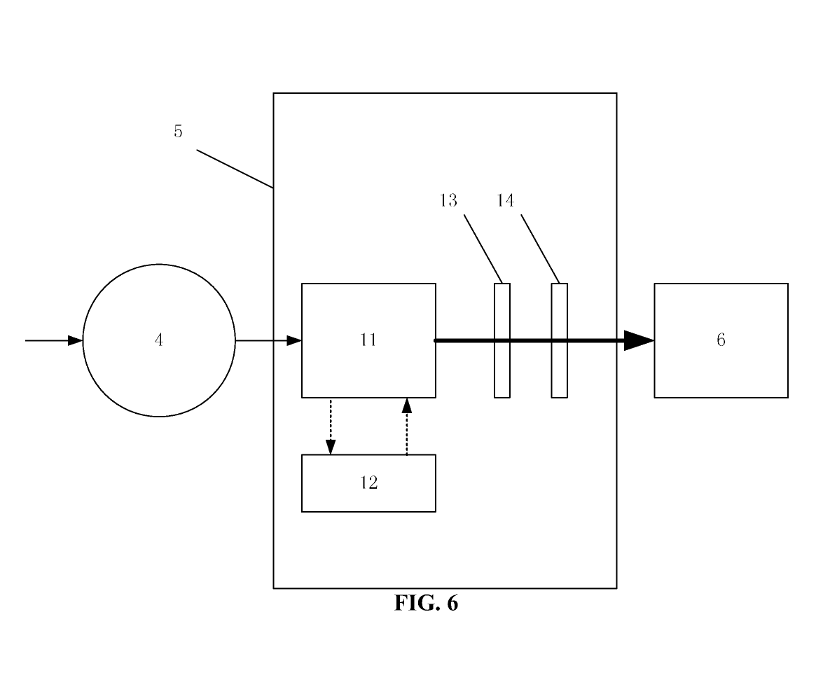

FIG. 6 shows a connection relationship of the laser generator 5: the VCSEL 11 is respectively connected with output port of Bias-Tee and the laser device temperature controller 12, and laser transmitted by the VCSEL 11 is outputted after passing the attenuator 13 and the λ/4 wave plate 14.

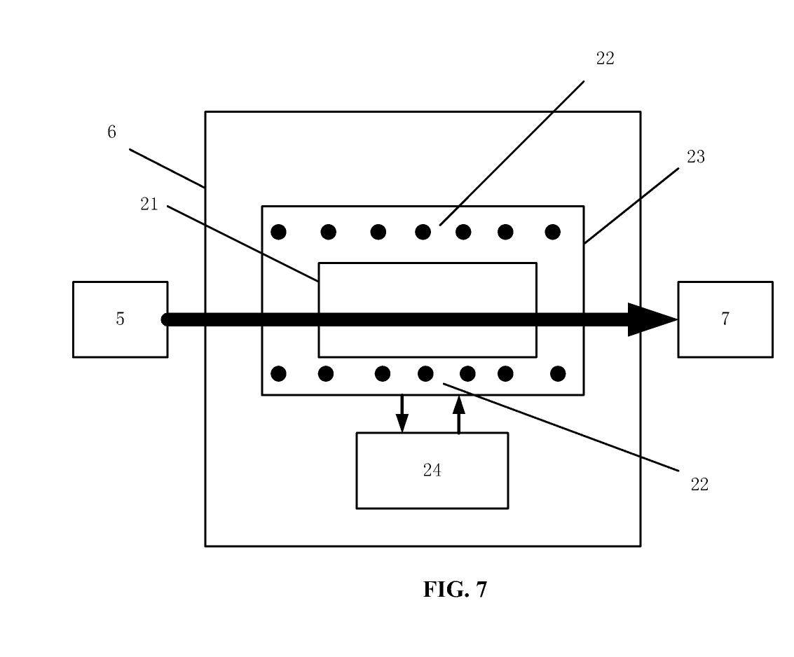

FIG. 7 shows a block diagram of the physical system. The atom sample bubble 21 is a sealed glass bubble charged with ⁸⁷Rb atom and buffer gas, and the atomic sample bubble is surrounded with a magnetic field coil 22 and a magnetic shielding layer 23. The temperature controller 24 provides stable working temperature of the atomic sample bubble. Polychromatic light generated and modulated by the laser generator 5 passes the atomic sample bubble and magnetic field coil along the axial direction.

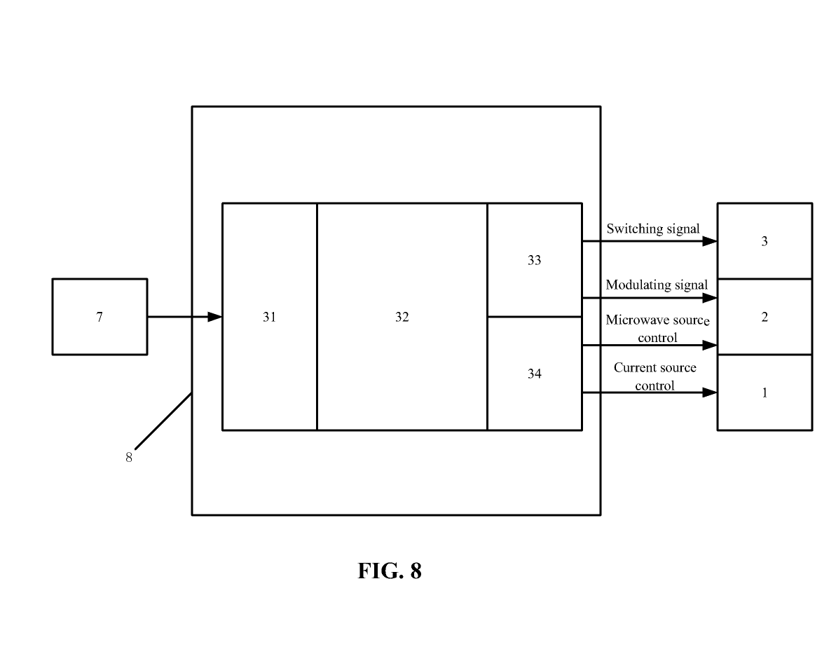

FIG. 8 shows a block diagram of the control equipment. The data collection card 31, control signal output card, and GPIB interface card 34 are PCI interface devices, which are installed on PCI interface of the computer 32. The data collection card 31 is connected with the output of the laser detector 7, which outputs an analog voltage signal. Digital quantity is acquired through discrete sampling and analog-digital conversion of the data collection card and is inputted into the computer for processing. Control signal outputs multi-channel digital signal controlled through computer software (FIG. 9), which are respectively connected with modulation triggering terminals of the microwave switch 3 and the microwave source 2, and the scan trigger terminal of the microwave source 2 for control of generation of microwave pulse and modulation and scan of the microwave. The computer 32 is connected with the current source 1 and the microwave source 2 through the GPIB interface card 34 for realization of under-control output of the current source 1 and the microwave source 2.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for forming an atomic clock, the method comprising:
a) connecting an output terminal of a current source to a DC input terminal of a DC bias element, connecting an output terminal of a microwave source to a high-frequency RF input terminal of the DC bias element through a microwave switch, coupling DC with microwave by the DC bias element to yield a current modulated with the microwave; feeding the current into a laser device to generate a coherent multi-side-band laser; adjusting adjacent side-band spacing with coupling microwave frequency, adjusting side-band amplitudes with microwave power to meet Bessel function mode, and selecting modulation index as approximately 1.6 so that an optical power of a plus/minus grade I side-band is maximum, adjusting output laser intensity through an attenuator, and adjusting output laser polarization direction by a λ/4 wave plate to generate a circular polarization laser;
b) feeding the circular polarization laser into an atom sample bubble to interact with an alkali-metal atom, and measuring a transmitted light intensity through a laser detector; controlling the current source through control equipment for DC scanning to change a fundamental frequency of laser outputted by the laser device, and recording transmitted light intensity to get multiple absorption peaks generated by interaction between polychromatic light and three-level of the atom; after completion of scanning, setting the output current of the current source as the current value corresponding to a maximum absorption peak;
c) modulating the output current, and demodulating detection light intensity to get differential curve corresponding to absorption peak; based on feedback DC of the differential curve, adjusting DC output to correspond to the maximum absorption peak, and allowing frequency f₁ and f₂ of the plus/minus grade I side-band of the laser outputted by the laser device to correspond to transition frequency ν₁ and ν₂ between two basic states and excited state in an atom three-level structure model;
d) controlling the microwave switch to produce a cyclic microwave pulse to achieve cyclic interaction between the laser and the atom, each cycle t₀ comprising two pulses, duration time of a first pulse and a second pulse being τ₁ and τ₂, respectively, an interval time between two pulses being T, an interval time between the second pulse and the first pulse of a next cycle being T′; upon the duration time τ₁ and τ₂, turning on the microwave by the microwave switch, modulating the laser device to output polychromatic light having fundamental frequency f₀ and interval Δf/2, in which plus/minus grade I side-band f₁ and f₂ interact with the atom to prepare CPT state and generate Ramsey interference; turning off the microwave by the microwave switch upon the interval time T so that the laser device outputs homogeneous light, laser frequency is off resonance, the atom evolves freely; turning off the microwave by the microwave switch upon the interval time T′ to eliminate the effect of the last cycle; controlling the microwave source through the control equipment for scanning the microwave frequency, changing frequency difference of the plus/minus grade I side-band outputted by the laser device, recording transmitted light intensity to get a Ramsey-CPT interference fringe having a narrow line width and high signal noise ratio; and
e) modulating the microwave frequency through controlling the microwave source by the control equipment, and demodulating light intensity to get differential curve corresponding to the Ramsey-CPT interference fringe; employing a central fringe as a frequency discrimination signal, locking the microwave frequency at maximum peak position of the central fringe to output stable frequency of the atomic clock.

2. A device for forming an atomic clock, the device comprising:
a) a current source comprising an output terminal;
b) a microwave source comprising an output terminal;
c) a microwave switch;
d) a DC bias element comprising a DC bias input terminal;
e) a laser generator;
f) a physical system;
g) a laser detector comprising an output terminal; and
h) control equipment;
wherein
the output terminal of the current source is connected with the DC bias input terminal of the DC bias element, and the output terminal of the microwave source is connected with the microwave switch;
the DC bias element is a three-port device comprising two input terminals and one output port, the two input terminals are respectively connected with the current source and the microwave switch, and the output port is connected with the laser generator;
the current source and microwave source provide bias current and microwave modulation to the laser generator connected with the output port of the DC bias element;
laser outputted by the laser generator projects onto the laser detector through the physical system;
the control equipment is connected with the current source, microwave source, microwave switch, and the output terminal of the laser detector;
the control equipment collects and processes voltage signal outputted by laser detector, and controls the output of the current source and microwave source and on/off of the microwave switch.

3. The device of claim 2, wherein
the laser generator comprises a vertical cavity surface emitting laser device (VCSEL), laser device temperature controller, attenuator, and λ/4 wave plate;
the vertical cavity surface emitting laser device is connected with the output port of the DC bias element and the laser device temperature controller; and
laser transmitted by the vertical cavity surface emitting laser device is outputted after passing the attenuator and λ/4 wave plate.

4. The device of claim 2, wherein
the physical system comprises an atomic sample bubble, magnetic field coil, magnetic shielding layer, and temperature controller;
the atomic sample bubble is a sealed glass bubble charged with 87Rb atom and buffer gas;
the atomic sample bubble is surrounded with the magnetic field coil and the magnetic shielding layer;
the temperature controller provides stable working temperature for the atomic sample bubble; and
polychromatic light generated and modulated by the laser generator passes along the axial direction of the atomic sample bubble and magnetic field coil to prepare CPT state.

5. The device of claim 2, wherein the control equipment comprises data collection hardware, a computer/micro-controller, signal output hardware, and a communication interface.
